(19) United States
(12) Patent Application Publication
(10) Pub. No.: US 2009/0195302 A1
(43) Pub. Date: Aug. 6, 2009

(54) REFERENCE BUFFER

(75) Inventors: Yu-Hsin Lin, Taipei City (TW); Hsueh-Kun Liao, Hsin-Chu Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/025,085

(22) Filed: Feb. 4, 2008

(51) Int. Cl. G05F 3/02

(52) U.S. Cl. 327/543

(57) ABSTRACT

A reference buffer is disclosed. The reference buffer includes a main source follower stage, a replica source follower stage, and a low-pass filter. The main source follower stage provides a first main voltage according to a first driving voltage. The replica source follower stage duplicates the first main voltage to generate a first reference voltage. The low-pass filter is coupled between the main source follower stage and the replica source follower stage.

### BACKGROUND OF THE INVENTION

1. Field of the Invention

The invention relates to a reference buffer, and more particularly to a close loop reference buffer.

2. Description of the Related Art

In analog circuits, operational amplifiers (OP-AMPs) are integrated circuits (IC) having various capabilities and functions. OP-AMPs are typically utilized in linear circuits for amplifying analog signals, such as video signals, temperature signals, pressure signals, velocity signals or sine waves. FIG. 1a is a schematic diagram of an OP-AMP. The OP-AMP 10 comprises two power terminals, an output, a non-inverting input (+), and an inverting input (−). To simplify the diagram, the power terminals are omitted, as shown in FIG. 1b.

Feedback, typically negative, is applied in OP-AMPs. When a resistor or a capacitor is coupled between the inverting input and the output of an OP-AMP, the negative feedback is complete. If feedback is not applied to the OP-AMP, the circuit comprising the OP-AMP is called an open loop. If the OP-AMP applies the feedback, the circuit comprising the OP-AMP is called a closed loop. FIG.2 is a schematic diagram of a reference buffer. The output impedance of the reference buffer can be reduced due to its negative feedback, and thus the reference buffer can quickly settle to drive a load.

In order to keep its output impedance low at high frequency, the reference buffer needs to have a high open loop gain at high frequency, thus increasing the power consumption. Moreover, when the gain is higher, noise is correspondingly increased. Therefore, the conventional reference buffer utilizing the negative feedback is difficult to achieve low noise, high gain and low power consumption simultaneously.

### BRIEF SUMMARY OF THE INVENTION

Reference buffers are provided. An exemplary embodiment of a reference buffer comprises a main source follower stage, a replica source follower stage, and a low-pass filter. The main source follower stage provides a first main voltage according to a first driving voltage. The replica source follower stage duplicates the first main voltage to generate a first reference voltage. The low-pass filter is coupled between the main source follower stage and the replica source follower stage.

Another exemplary embodiment of a reference buffer comprises a main source follower stage and a replica source follower stage. The main source follower stage comprises a first transistor for providing a first main voltage according to a first driving voltage. The replica source follower stage comprises a second transistor for duplicating the first main voltage to generate a first reference voltage. The first and second transistors are native transistors.

Another exemplary embodiment of a reference buffer comprises a first operational amplifier, a second operational amplifier, a first transistor, a second transistor, a first low-pass filtering circuit, a third transistor, a fourth transistor and a second low-pass filtering circuit. The first operational amplifier comprises a non-inverting input receiving a first driving voltage. The second operational amplifier comprises a non-inverting input receiving a second driving voltage. The first transistor comprises a gate coupled to an output of the first operational amplifier and a source outputting a first main voltage. The second transistor comprises a gate receiving the first main voltage and a source outputting a first reference voltage. The first low-pass filtering circuit is coupled between the gates of first and second transistors. The third transistor comprises a gate coupled to an output of the second operational amplifier and a source outputting a second main voltage. The fourth transistor comprises a gate receiving the second main voltage and a source outputting the second reference voltage. The second low-pass filtering circuit is coupled between the gates of third and fourth transistors.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIGS. 1a and 1b are schematic diagrams of an OP-AMP;

FIG. 2 is a schematic diagram of a reference buffer;

FIG. 3 is a schematic diagram of an exemplary embodiment of a reference buffer;

FIG. 4 is a schematic diagram of another exemplary embodiment of a reference buffer;

FIG. 5 is a schematic diagram of another exemplary embodiment of a reference buffer; and

FIG. 6 is a schematic diagram of another exemplary embodiment of a reference buffer.

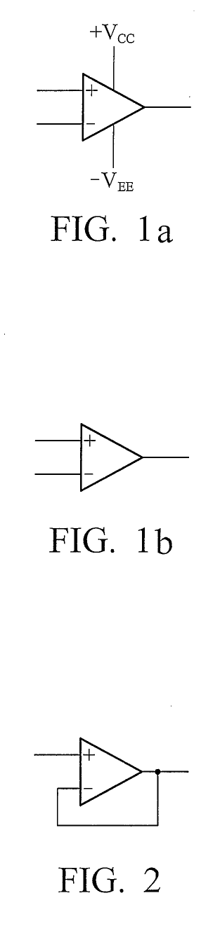

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

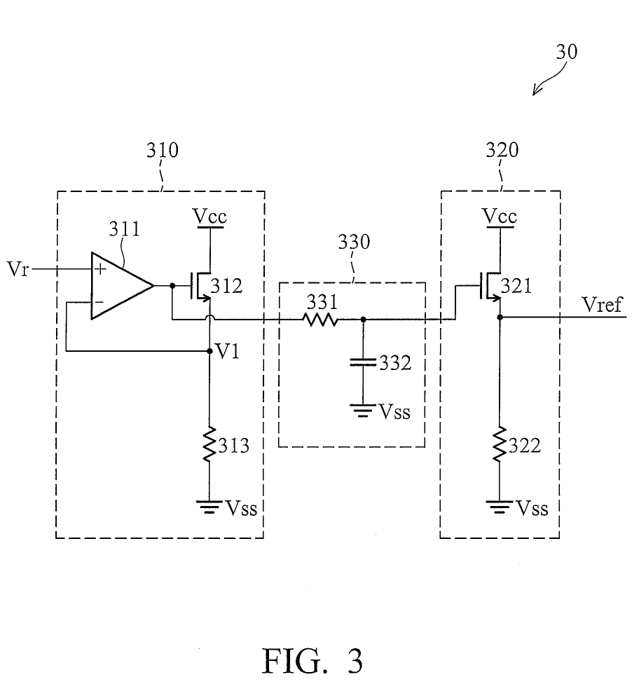

FIG. 3 is a schematic diagram of an exemplary embodiment of a reference buffer. The reference buffer 30 comprises a main source follower stage 310, a replica source follower stage 320, and a low-pass filter, e.g. a low-pass filtering circuit 330.

The main source follower stage 310 provides a main voltage VI according to a driving voltage Vr. The replica source follower stage 320 duplicates the main voltage V1 to generate a reference voltage Vref. The low-pass filtering circuit 330 is coupled between the main source follower stage 310 and the replica source follower stage 320.

The main source follower stage 310 comprises an operational amplifier 311 and a transistor 312. The driving voltage Vr is received by the non-inverting input (+) of the operational amplifier 311. The transistor 312 is coupled to the operational amplifier 311 for providing the main voltage V1. The main voltage V1 is approximately equal to the driving voltage Vr.

In this embodiment, the main source follower stage 310 further comprises a resistor 313 coupled between the source of the transistor 312 and voltage Vss. The gate of the transistor 312 is coupled to the output of the operational amplifier 311 and the low-pass filtering circuit 330. The drain of the transistor 312 receives voltage Vcc and the source of the transistor 312 is coupled to the inverting input (−) of the operational amplifier 311 for outputting the main voltage V1.

The replica source follower stage 320 comprises a transistor 321. The transistor 321 comprises a gate coupled to the low-pass filtering circuit 330, a drain receiving the voltage Vcc, and a source outputting the reference voltage Vref. In this embodiment, the replica source follower stage 320 further comprises a resistor 322 coupled between the transistor 321 and the voltage Vss.

The low-pass filtering circuit 330 is coupled to the main source follower stage 310 and the replica source follower stage 320 to stabilize voltage of the gate of the transistor 321. The low-pass filtering circuit 330 is well known to those skilled in the art, thus, description thereof is omitted. Suitable low-pass filters can be utilized in the embodiments. In this embodiment, the low-pass filtering circuit 330 comprises a resistor 331 and a capacitor 332. The resistor 331 is coupled between the transistors 312 and 321. The capacitor 332 is coupled between the gate of the transistor 321 and the voltage Vss less than the voltage Vcc.

The transistors 312 and 321 are NMOS transistors. In this embodiment, the transistors 312 and 321 are specific elements, e.g. native transistors, such that the transistors 312 and 321 may have low threshold voltages, a zero threshold voltage or native threshold voltages. For example, when the reference buffer 30 is operated in a low voltage system, the voltage Vcc may be equal to about 1.8 volts. The ranges of the threshold voltages are not greater than 0.4 volts, such as from 0.4 volts to −0.1 volts. In some embodiments, the transistors 312 and 321 are produced by 0.18 micron gate-width technology.

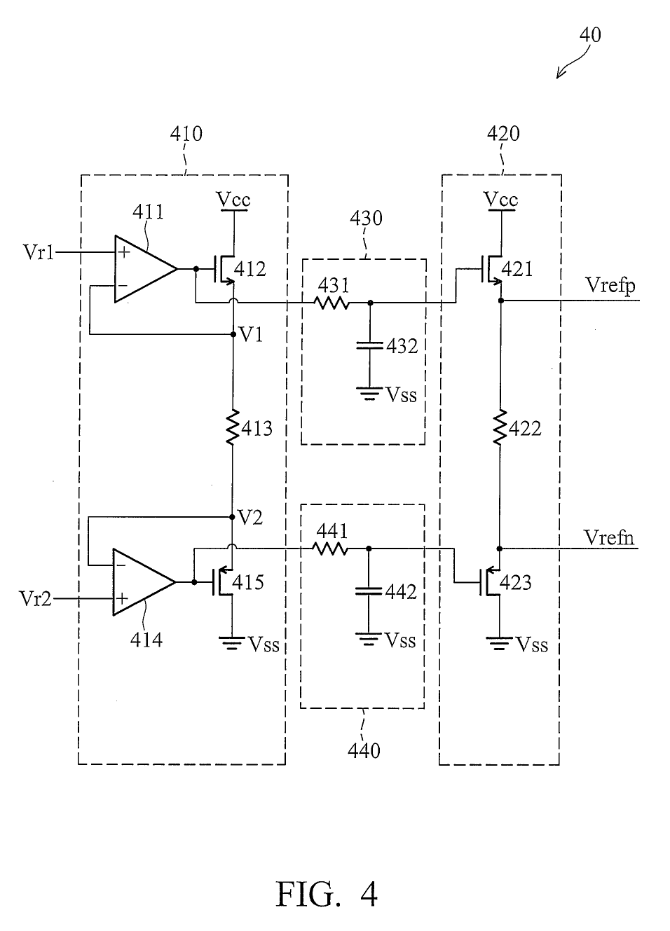

FIG. 4 is a schematic diagram of another exemplary embodiment of a reference buffer. The reference buffer 40 comprises a main source follower stage 410, a replica source follower stage 420, and a low-pass filter comprising two low-pass filtering circuits 430 and 440.

The main source follower stage 410 provides main voltages V1 and V2 according to driving voltages Vr1 and Vr2, respectively. The replica source follower stage 420 duplicates the main voltages V1 and V2 to generate reference voltages Vrefp and Vrefn, respectively. The low-pass filtering circuits 430 and 440 are coupled between the main source follower stage 410 and the replica source follower stage 420.

The main source follower stage 410 comprises operational amplifiers 411 and 414, transistors 412 and 415, and a resistor 413. The driving voltage Vr1 is received by the non-inverting input (+) of the operational amplifier 411. The transistor 412 comprises a gate coupled to the output of the operational amplifier 411 and the low-pass filtering circuit 430, a drain receiving the voltage Vcc, and a source coupled to the inverting input (−) of the operational amplifier 411 for outputting the main voltage V1. The driving voltage Vr1 is thus approximately equal to the main voltage V1.

The driving voltage Vr2 is received by the non-inverting input (+) of the operational amplifier 414. The transistor 415 comprises a gate coupled to the output of the operational amplifier 414 and the low-pass filtering circuit 440, a drain receiving the voltage Vss, a source coupled to the inverting input (−) of the operational amplifier 414 for outputting the main voltage V2. The main voltage V2 is thus approximately equal to the driving voltage Vr2. In this embodiment, the resistor 413 is coupled between the sources of the transistors 412 and 415.

The replica source follower stage 420 comprises transistors 421 and 423. The transistor 421 duplicates the main voltage V1 to generate the reference voltage Vrefp and comprises a gate coupled to the low-pass filtering circuit 430 and the gate of the transistor 412, a drain receiving the voltage Vcc, and a source outputting the reference voltage Vrefp. The transistor 423 duplicates the main voltage V2 to generate the reference voltage Vrefn and comprises a gate coupled to the low-pass filtering circuit 440 and the gate of the transistor 415, a drain receiving the voltage Vss, and a source outputting the reference voltage Vrefn. In this embodiment, the replica source follower stage 420 further comprises a resistor 422 coupled between the sources of the transistors 421 and 423.

The low-pass filtering circuit 430 is coupled to the gates of the transistors 412 and 421 for stabilizing voltage of the gate of the transistor 421. The low-pass filtering circuit 440 is coupled to the gates of the transistors 415 and 423 for stabilizing voltage of the gate of the transistor 423. The low-pass filtering circuit is well known to those skilled in the art, thus, description thereof is omitted. In this embodiment, the low-pass filtering circuit 430 comprises a resistor 431 and a capacitor 432. The resistor 431 is coupled between the transistors 412 and 421. The capacitor 432 is coupled between the gate of the transistor 421 and the voltage Vss less than the voltage Vcc. The low-pass filtering circuit 440 comprises a resistor 441 and a capacitor 442. The resistor 441 is coupled between the transistors 415 and 423. The capacitor 442 is coupled between the gate of the transistor 423 and the voltage Vss less than the voltage Vcc.

The transistors 412 and 421 are NMOS transistors and the transistors 415 and 423 are PMOS transistors. In this embodiment, the transistors 412, 421, 415 and 423 are specific elements, e.g. native transistors, such that the transistors 412, 421, 415 and 423 may have low threshold voltages, a zero threshold voltage, or native threshold voltages. For example, when the reference buffer 40 operates in a low voltage system, the voltage Vcc may be equal to 1.8 volts. The ranges of the threshold voltages are not greater than 0.4 volts, such as from 0.4 volts to −0.1 volts. In some embodiments, the transistors 412, 421, 415 and 423 are produced by 0.18 micron gate-width technology.

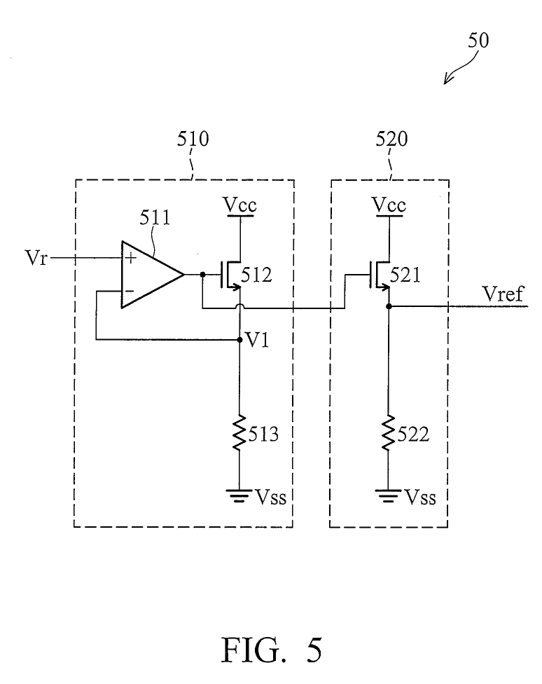

FIG. 5 is a schematic diagram of another exemplary embodiment of a reference buffer. The reference buffer 50 comprises a main source follower stage 510 and a replica source follower stage 520. The main source follower stage 510 comprises a transistor 512 for providing a main voltage V1 according to a driving voltage Vr. The replica source follower stage 520 comprises a transistor 521 for duplicating the main voltage V1 to generate a reference voltage Vref.

The transistors 512 and 521 are NMOS transistors. In this embodiment, the transistors 512 and 521, e.g. native transistors, may have low threshold voltages, a zero threshold voltage, or native threshold voltages. The ranges of the threshold voltages are from 0.4 volts to −0.1 volts. Thus, the reference buffer 50 can be operated in a low voltage system. In some embodiments, the transistors 512 and 521 are produced by 0.18 micron gate-width technology.

The main source follower stage 510 further comprises an operational amplifier 511 comprising a non-inverting input (+) receiving the driving voltage Vr, an inverting input (−) and an output coupled to the transistor 512. The main voltage V1 is approximately equal to the driving voltage Vr. In this embodiment, the main source follower stage 510 further comprises a resistor 513 coupled between the transistor 512 and the voltage Vss. The transistor 512 comprises a gate coupled to the output of the operational amplifier 511, a drain receiving the voltage Vcc, and a source coupled to the inverting input (−) of the operational amplifier 511 and the resistor 513.

The replica source follower stage 520 further comprises a resistor 522 coupled between the transistor 521 and the voltage Vss less than the voltage Vcc. In this embodiment, the transistor 521 comprises a gate coupled to the output of the operational amplifier 511, a drain receiving the voltage Vcc and a source outputting the reference voltage Vref.

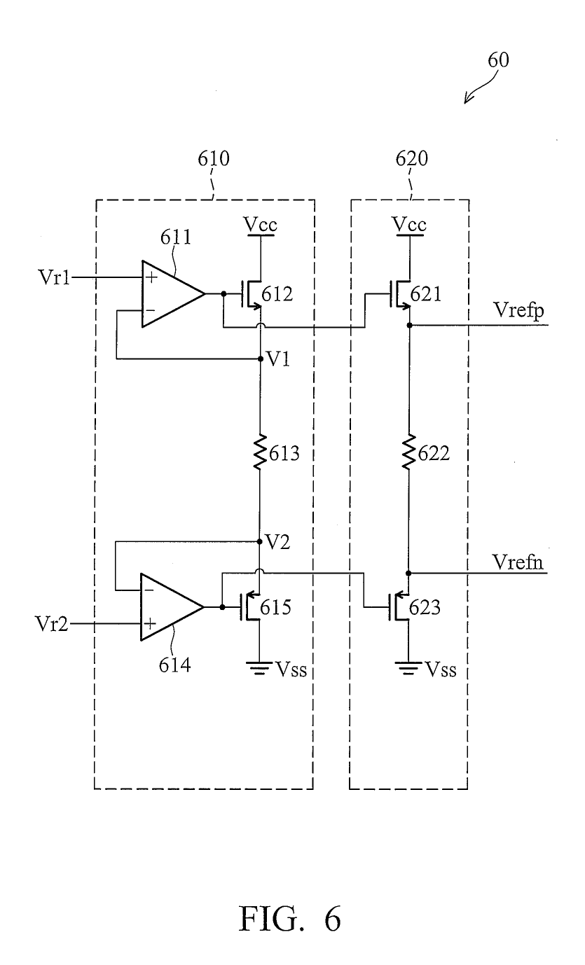

FIG. 6 is a schematic diagram of another exemplary embodiment of a reference buffer. The reference buffer 60 comprises a main source follower stage 610 and a replica source follower stage 620. The main source follower stage 610 comprises transistors 612 and 615. The transistor 612 provides a main voltage V1 according to a driving voltage Vr1. The transistor 615 provides a main voltage V2 according to a driving voltage Vr2. The replica source follower stage 620 comprises transistors 621 and 623. The transistor 621 duplicates the main voltage V1 to generate a reference voltage Vrefp. The transistor 623 duplicates the main voltage V2 to generate a reference voltage Vrefn.

The transistors 612 and 621 are NMOS transistors, and the transistors 615 and 623 are PMOS transistors. In this embodiment, the transistors 612, 621, 615 and 623, e.g. native transistors, may have low threshold voltages, a zero threshold voltage, or native threshold voltages. The ranges of the threshold voltages are from 0.4 volts to −0.1 volts. Thus, the reference buffer 60 can be operated in a low voltage system. In some embodiments, the transistors 612, 621, 615 and 623 are produced by 0.18 micron gate-width technology.

The main source follower stage 610 further comprises operational amplifiers 611 and 614. The operational amplifier 611 comprises a non-inverting input (+) receiving the driving voltage Vr1, an inverting input (−) and an output coupled to the transistor 612. The operational amplifier 614 comprises a non-inverting input (+) receiving the driving voltage Vr2, an inverting input (−) and an output coupled to the transistor 615. The main voltage V1 is approximately equal to the driving voltage Vr1. The main voltage V2 is approximately equal to the driving voltage Vr2.

In this embodiment, the main source follower stage 610 further comprises a resistor 613 coupled between the transistors 612 and 615. The transistor 612 comprises a gate coupled to the output of the operational amplifier 611, a drain receiving the voltage Vcc, and a source coupled to the inverting input (−) of the operational amplifier 611 and the resistor 613. The transistor 615 comprises a gate coupled to the output of the operational amplifier 614, a drain receiving the voltage Vss, and a source coupled to the inverting input (−) of the operational amplifier 614 and the resistor 613.

The replica source follower stage 620 further comprises a resistor 622 and a transistor 623. The resistor 622 is coupled between the transistors 621 and 623. In this embodiment, the transistor 621 comprises a gate coupled to the output of the operational amplifier 611, a drain receiving the voltage Vcc and a source outputting the reference voltage Vrefp. The transistor 623 comprises a gate coupled to the output of the operational amplifier 614, a drain receiving the voltage Vss and a source outputting the reference voltage Vrefn.

Accordingly, the embodiments can be operated in low voltages due to the native transistors. Moreover, the low-pass filter can suppress the bandwidth of transistors and operational amplifiers (e.g. the main source follower stage) to filter out noise, and make the ground impedance of transistors (e.g. the replica source follower stage) low at high frequency to avoid the reference voltage from coupling the noise from the gates. In addition, the embodiments have lower power consumption since the reference buffers are open loops.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A reference buffer, comprising:
a main source follower stage comprising a first transistor for providing a first main voltage according to a first driving voltage; and
a replica source follower stage comprising a second transistor for duplicating the first main voltage to generate a first reference voltage, wherein the first and second transistors are native transistors.

2. The reference buffer as claimed in claim 1, wherein threshold voltages of the first and second transistors are not greater than 0.4 volts.

3. The reference buffer as claimed in claim 1, wherein the main source follower stage further comprises a first operational amplifier comprising a non-inverting input receiving the first driving voltage, an inverting input and an output coupled to the first transistor, wherein the first transistor comprises a gate coupled to the output of the first operational amplifier, a drain receiving a first voltage and a source coupled to the inverting input of the first operational amplifier, and the second transistor comprises a gate coupled to the output of the first operational amplifier, a drain receiving the first voltage and a source outputting the first reference voltage.

4. The reference buffer as claimed in claim 3, wherein the main source follower stage further comprises:
a second operational amplifier comprising a non-inverting input receiving a second driving voltage, an inverting input and an output;
a third transistor coupled to the output of the second operational amplifier for providing a second main voltage according to the second driving voltage; and
a first resistor coupled between the first and third transistors; and
the replica source follower stage further comprises:
a fourth transistor duplicating the second main voltage to generate a second reference voltage; and
a second resistor coupled between the second and fourth transistors;
wherein the third and fourth transistors are native transistors.

5. The reference buffer as claimed in claim 4, wherein the third transistor comprises a gate coupled to the output of the second operational amplifier, a drain receiving a second voltage and a source coupled to the inverting input of the second operational amplifier; wherein the fourth transistor comprises a gate coupled to the output of the second operational amplifier, a drain receiving the second voltage and a source outputting the second reference voltage, the first resistor is coupled between the sources of the first and third transistors, and the second resistor is coupled between the sources of the second and fourth transistors.

6. The reference buffer as claimed in claim 4, wherein threshold voltages of the first, second, third and fourth transistors are not greater than 0.4 volts.

7. A reference buffer, comprising:
a main source follower stage providing a first main voltage according to a first driving voltage;
a replica source follower stage duplicating the first main voltage to generate a first reference voltage; and
a low-pass filter coupled between the main source follower stage and the replica source follower stage.

8. The reference buffer as claimed in claim 7, wherein the main source follower stage comprises:
a first operational amplifier comprising a non-inverting input receiving the first driving voltage, an inverting input and an output; and
a first transistor comprising a gate coupled to the output of the first operational amplifier and the low-pass filter, a drain receiving a first voltage and a source coupled to the inverting input of the first operational amplifier, for outputting the first main voltage;
the replica source follower stage comprises:
a second transistor comprising a gate coupled to the low-pass filter, a drain receiving the first voltage, and a source outputting the first reference voltage; and
the low-pass filter comprises:
a first low-pass filtering circuit comprising a resistor connected between the gates of the first and second transistors, and a capacitor connected between the gate of the second transistor and a second voltage.

9. The reference buffer as claimed in claim 8, wherein the first and second transistors are native transistors.

10. The reference buffer as claimed in claim 8, wherein threshold voltages of the first and second transistors are not greater than 0.4 volts.

11. The reference buffer as claimed in claim 8, wherein the main source follower stage further comprises:
a second operational amplifier comprising a non-inverting input receiving a second driving voltage, an inverting input and an output;
a third transistor comprising a gate coupled to the output of the second operational amplifier and the low-pass filter, a drain receiving the second voltage and a source coupled to the inverting input of the second operational amplifier, for outputting a second main voltage; and
a first resistor coupled between the sources of the first and third transistors;
the replica source follower stage comprises:
a fourth transistor comprising a gate coupled to the output of the second operational amplifier, a drain receiving the second voltage and a source outputting the second reference voltage; and
a second resistor coupled between the sources of the second and fourth transistors; and
the low-pass filter further comprises:
a second low-pass filtering circuit comprising a resistor connected between the gates of the third and fourth transistors, and a capacitor connected between the gate of the fourth transistor and the second voltage.

12. The reference buffer as claimed in claim 11, wherein the first, second, third and fourth transistors are native transistors.

13. The reference buffer as claimed in claim 11, wherein threshold voltages of the first, second, third and fourth transistors are not greater than 0.4 volts.

14. A reference buffer, comprising:
a first operational amplifier comprising a non-inverting input receiving a first driving voltage;
a second operational amplifier comprising a non-inverting input receiving a second driving voltage;
a first transistor comprising a gate coupled to an output of the first operational amplifier and a source outputting a first main voltage;
a second transistor comprising a gate receiving the first main voltage and a source outputting a first reference voltage;
a first low-pass filtering circuit coupled between the gates of first and second transistors;
a third transistor comprising a gate coupled to an output of the second operational amplifier and a source outputting a second main voltage;
a fourth transistor comprising a gate receiving the second main voltage and a source outputting the second reference voltage; and
a second low-pass filtering circuit coupled between the gates of third and fourth transistors.

15. The reference buffer as claimed in claim 14, wherein the first, second, third and fourth transistors are native transistors.

16. The reference buffer as claimed in claim 14, wherein threshold voltages of the first, second, third and fourth transistors are not greater than 0.4 volts.

17. The reference buffer as claimed in claim 14, wherein the first low-pass filtering circuit comprises a resistor connected between the gates of the first and second transistors and a capacitor connected between the gate of the second transistor and a second voltage, and the second low-pass filtering circuit comprises a resistor connected between the gates of the third and fourth transistors and a capacitor connected between the gate of the fourth transistor and the second voltage.

18. The reference buffer as claimed in claim 14, further comprising:
a first resistor coupled between the sources of the first and third transistors; and
a second resistor coupled between the sources of the second and fourth transistors.
